(19) United States
(12) Patent Application Publication
(10) Pub. No.: US 2026/0255377 A1
(43) Pub. Date: Aug. 27, 2026

(54) CHANNEL-AWARE CODE BLOCK GROUP PARTITIONING

(71) Applicant: QUALCOMM Incorporated, San Diego, CA (US)

(72) Inventors: Aviv REGEV, Tel Aviv (IL); Ronen SHAKED, Kfar Saba (IL); Shay LANDIS, Hod Hasharon (IL); Jacob PICK, Mevaseret Zion (IL); Amit BAR-OR TILLINGER, Tel Aviv (IL)

(21) Appl. No.: 19/060,220

(22) Filed: Feb. 21, 2025

(51) Int. Cl. H04W 72/53; H04B 17/336; H04L 1/00; H04W 72/54

(52) U.S. Cl. CPC H04W 72/53; H04B 17/336; H04L 1/0009; H04L 1/0057; H04W 72/54

(57) ABSTRACT

Certain aspects of the present disclosure provide techniques for wireless communications. An example method includes obtaining, from a network entity, a request for a partitioning scheme for a plurality of code block groups (CBGs) of a transport block (TB), the partitioning scheme indicating a partitioning of a plurality of code blocks (CBs) of the TB into the plurality of CBGs based on a channel condition for transmission of the TB; and communicating with the network entity in accordance with the partitioning scheme.

### INTRODUCTION

### Field of the Disclosure

Aspects of the present disclosure relate to wireless communications, and more particularly, to techniques for code block group (CBG) partitioning schemes.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes obtaining, from a network entity, a request for a partitioning scheme for a plurality of code block groups (CBGs) of a transport block (TB), the partitioning scheme indicating a partitioning of a plurality of code blocks (CBs) of the TB into the plurality of CBGs based on a channel condition for transmission of the TB; and communicating with the network entity in accordance with the partitioning scheme.

Certain aspects provide a method for wireless communications by a network entity. The method includes sending, to a UE, a request for a partitioning scheme for a plurality of CBGs of a TB, the partitioning scheme indicating a partitioning of a plurality of CBs of the TB into the plurality of CBGs based on a channel condition for transmission of the TB; and communicating with the UE in accordance with the partitioning scheme.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts an example code block group (CBG) partitioning scheme.

FIG. 6 depicts an example CBG partitioning scheme.

FIG. 7 depicts an example wireless communications network.

FIG. 8 depicts an example channel-aware CBG partitioning scheme.

FIG. 9 depicts an example process flow for communications in a network between a network entity and a UE.

FIG. 10 depicts a method for wireless communications.

FIG. 11 depicts another method for wireless communications.

FIG. 12 depicts aspects of an example communications device.

FIG. 13 depicts aspects of an example communications device.

### DETAILED DESCRIPTION

Aspects of the present disclosure provide apparatuses, methods, processing systems, and computer-readable mediums for enabling a channel-aware code block group (CBG) partitioning scheme.

A wireless communication system may include a number of devices and network entities employing techniques for exchanging information wirelessly. For example, a wireless communication system may include devices (e.g., user equipments (UEs)) and network entities (e.g., base stations (BSs)) that wirelessly communicate data, control information, reference signals, etc. (e.g., according to various wireless communication system implementations). The wireless communication system may employ various technologies to improve throughput, achieve a high data rate, and/or improve the energy efficiency of the wireless communication system. These technologies may allow a wireless communication system to support communication between an increasing number of devices and network entities, support advanced functionalities at various devices, and improve the quality of communication between devices and network entities.

In some aspects, a device (e.g., UE, network entity, etc.) receiving a communication may provide feedback regarding the communication. Typically, feedback can have one of two binary states: an acknowledgment (ACK) indicating that the device successfully received the communication associated with the feedback (e.g., the communication was successfully decoded and processed), or a negative ACK (NACK) indicating that the device did not successfully receive the communication associated with the feedback (e.g., the communication was unsuccessfully decoded and/or processed). One form of feedback is hybrid automatic repeat request (HARQ) feedback, though aspects described herein are not limited to HARQ feedback.

Providing feedback in this above-described fashion enables a transmitter of the communication to determine when the communication should be retransmitted. For example, if the device sends a NACK feedback indication to the transmitter for the communication, the transmitter may retransmit all or a portion of the communication to the device. In some aspects, the device may provide an ACK/NACK feedback indication for every transport block (TB) (e.g., a payload or “block” of data delivered by a medium access control (MAC) layer to a physical (PHY) layer and/or delivered by the PHY later to the MAC layer) sent by the transmitter, and according to the feedback, the transmitter may retransmit the entire data of a TB if the device provides a NACK feedback indication for the TB. Additionally or alternatively, the device may provide an ACK/NACK feedback indication per CBG of a TB sent by the transmitter, and the transmitter may retransmit any CBGs for which the device provides a NACK feedback indication rather than retransmitting the entire data of the TB. For example, a TB may be segmented into a plurality of code blocks (CBs), and subsets of CBs of the plurality of CBs may be grouped and/or partitioned into respective CBGs, where the device attempts to decode the CBGs and provides ACK/NACK feedback per CBG. A CBG may include one or more CBs. The data of a TB may be transmitted via one or more CBGs. The device may provide one ACK/NACK per CBG.

One or more technical problems arise for the retransmission options described above. For example, the ACK/NACK feedback indication for every TB may result in an inefficient retransmission because the TB can be large in size (e.g., over one million bits in some cases), such that retransmitting the entire TB consumes a high amount of processing power and occupies a large amount of resources (e.g., time and frequency resources). Additionally, the device may provide a NACK feedback indication for the TB if any CBs of the TB are unsuccessfully received, even if the number of CBs that are unsuccessfully received is small and a majority of the CBs are successfully received. Subsequently, the transmitter may then retransmit all the CBs of the TB based on receiving the NACK feedback indication for the TB, resulting in wasteful transmission because the majority of the CBs have already been successfully received by the device.

Additionally or alternatively, the ACK/NACK feedback indication per CBG may mitigate the retransmission of the entire TB but may still lead to wasteful retransmission of CBs. For example, a partitioning scheme for the CBGs (e.g., how the CBs are allocated to respective CBGs) may be performed without taking channel conditions across different regions of an allocated bandwidth for the TB into consideration. That is, the partitioning of CBs into CBGs may be performed in a chronological order (e.g., in an earliest symbol, then in a next symbol, and so on, and in a frequency first fashion within a symbol), such that each CBG is continuous and with a same length. Accordingly, a CBG may include CBs that experience “good” channel conditions (e.g., high channel capacity) along with CBs that experience “bad” channel conditions (e.g., low channel capacity), which may lead to a CBG with capacity imbalances (and/or signal-to-noise ratio (SNR) imbalances) across its CBs. Such capacity imbalances may lead the device to unsuccessfully receive one or more CBs that experience the “bad” channel conditions (e.g., CBs with poor quality), resulting in the device sending a NACK feedback indication for the CBG with those CBs, whereas the majority of CBs in the CBG had good channel capacities and/or good SNRs and were successfully received by the device. However, based on receiving the NACK feedback indication for the CBG, the transmitter may retransmit the CBG, leading to a wasteful retransmission of the successfully received CBs.

The techniques and apparatuses described herein provide a CBG partitioning scheme that takes channel conditions into consideration (e.g., a channel-aware CBG partitioning scheme). For example, a first device transmitting one or more TBs (e.g., a network entity) may send a request to a second device receiving the one or more TBs (e.g., a UE), where the request indicates a partitioning scheme for CBGs of the one or more TBs. The partitioning scheme may be based on a channel condition for transmission of the one or more TBs. Subsequently, the first device and the second device may communicate in accordance with the partitioning scheme. Alternatively, the first device and the second device may communicate in accordance with a default partitioning scheme, where the default partitioning scheme corresponds to a determination of the CBGs irrespective of the channel condition (e.g., the partitioning of CBs into CBGs performed in a chronological order as described previously).

If the second device sends an indication that the request is approved, then the first device and the second device may communicate according to the partitioning scheme (e.g., the channel-aware CBG partitioning scheme). If the second device sends an indication that the request is disapproved, then the first device and the second device may communicate according to the default partitioning scheme. In some aspects, the partitioning scheme may be applied for the CBGs of the one or more TBs based on an indicated chosen policy by the first device. For example, the chosen policy may indicate that CBs are to be assigned to the CBGs based on a respective channel capacity for each CB, respective mutual information (MI) values for each CB, respective SNR values for each CB, respective signal strength measurements for each CB, or another metric that represents the channel condition for each CB.

As used herein, “channel capacity” may refer to a maximum rate, in bits per channel use, at which information can be sent that satisfy a threshold error probability (e.g., sent through a channel reliably). Channel capacity may be equal to a maximum of MI between an input and an output of the channel (e.g., where the maximization is with respect to the input distribution). As such, MI may quantify an amount of information shared between the input and the output of the channel or, in other words, may measure how much information gets through the channel.

In some aspects, the first device may send (e.g., when indicating the chosen policy) one or more threshold values for determination of the CBGs for the partitioning scheme. For example, a first CBG may include a first set of CBs that have a metric corresponding to the channel condition in a first range of threshold values (e.g. above a threshold value, or between a first threshold value and a second threshold value), and a second CBG may include a second set of CBs that have the metric in a second range of threshold values (e.g., between the second threshold value and a third threshold value, or below the second threshold value). In some aspects, the first range may indicate a better channel condition than the second range. Additionally, the first range and the second range may be non-overlapping with one another. In some aspects, rather than a plurality of CBs being partitioned to the CBGs in chronological order, the first set of CBs may be non-contiguous with one another in time, and/or the second set of CBs may be non-contiguous with one another in time.

In certain aspects, the techniques for enabling a channel-aware CBG partitioning scheme (e.g., a partitioning scheme that is based on a channel condition for transmission of a TB) as described herein may provide any of various beneficial effects and/or advantages. For example, the channel-aware CBG partitioning scheme may reduce the number of CBGs that are retransmitted, thereby reducing signaling overhead and reducing channel usage.

Additionally, the second device may choose between the channel-aware CBG partitioning scheme and the default partitioning scheme (e.g., based on approving or not approving the channel-aware CBG partitioning scheme), which may increase a reliability of successfully receiving the TB if the channel-aware CBG partitioning scheme is not supported and/or approved. In some aspects, the channel-aware CBG partitioning scheme may partition CBs that experience “bad” channel conditions into same CBG(s) and CBs that experience “good” channel conditions into same CBG(s). Accordingly, the CBs that experience the “bad” channel conditions may be confined to a small quantity of CBGs rather than being distributed across a higher quantity of the CBGs. Subsequently, the second device may send NACK feedback indication(s) for the small quantity of CBGs that include the CBs that experience the “bad” channel conditions (e.g., CBs that are unsuccessfully received by the second device), and the first device may retransmit those CBGs, which may be a smaller quantity of CBGs compared to when a plurality of CBs are partitioned to CBGs irrespective of the channel condition. As such, the retransmissions may include fewer CBs that were successfully received previously at the second device, thereby reducing wasteful retransmissions.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

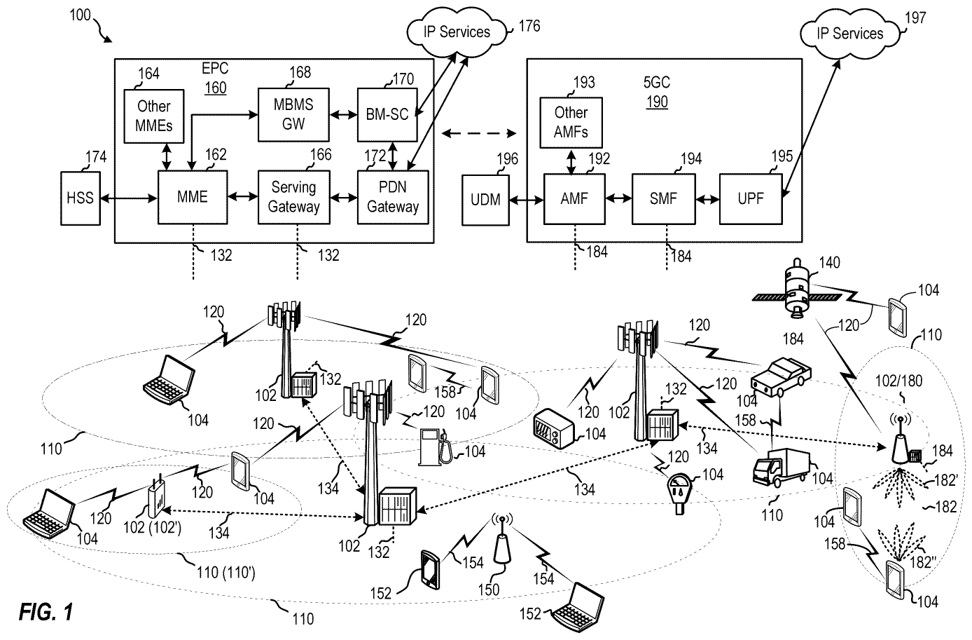

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a next generation NodeB (gNB or gNodeB) implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IOT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a gNB, an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

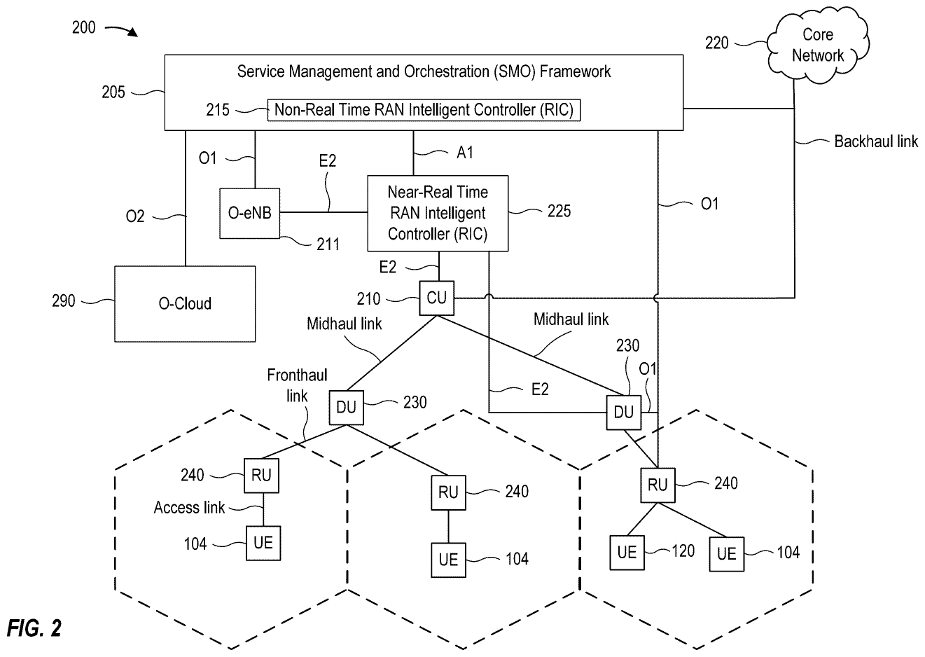

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G New Radio (NR) or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 megahertz (MHz)-7125 MHz, which is often referred to (interchangeably) as “Sub-6 gigahertz (GHz)”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QOS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

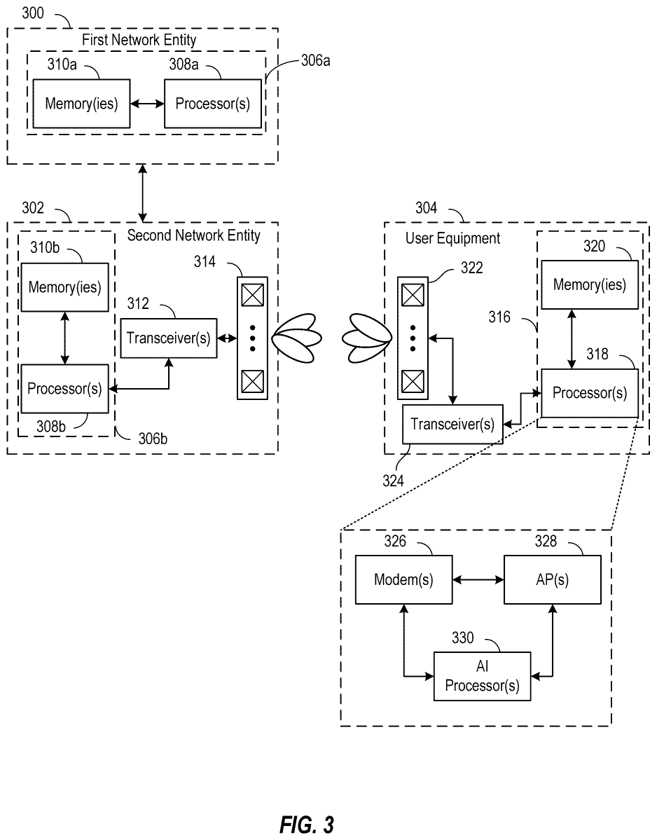

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a transmitter MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, a receiver MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a transmitter MIMO processor), further processed by the one or more transceivers 324 (e.g., for single-carrier frequency division multiplexing (SC-FDM)), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or a receiver MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

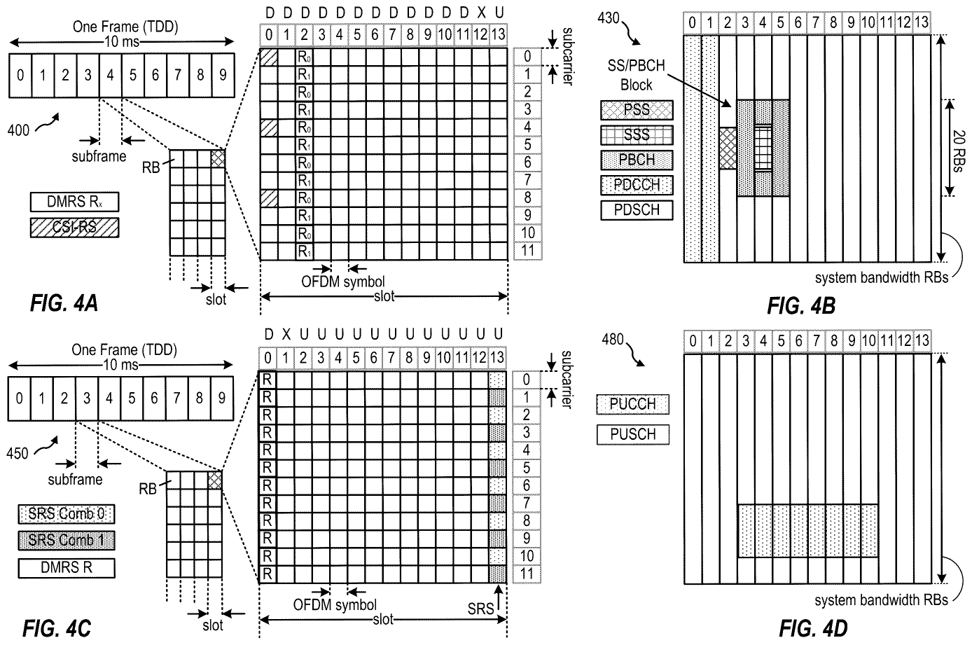

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and SC-FDM partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology u, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to CBG Partitioning

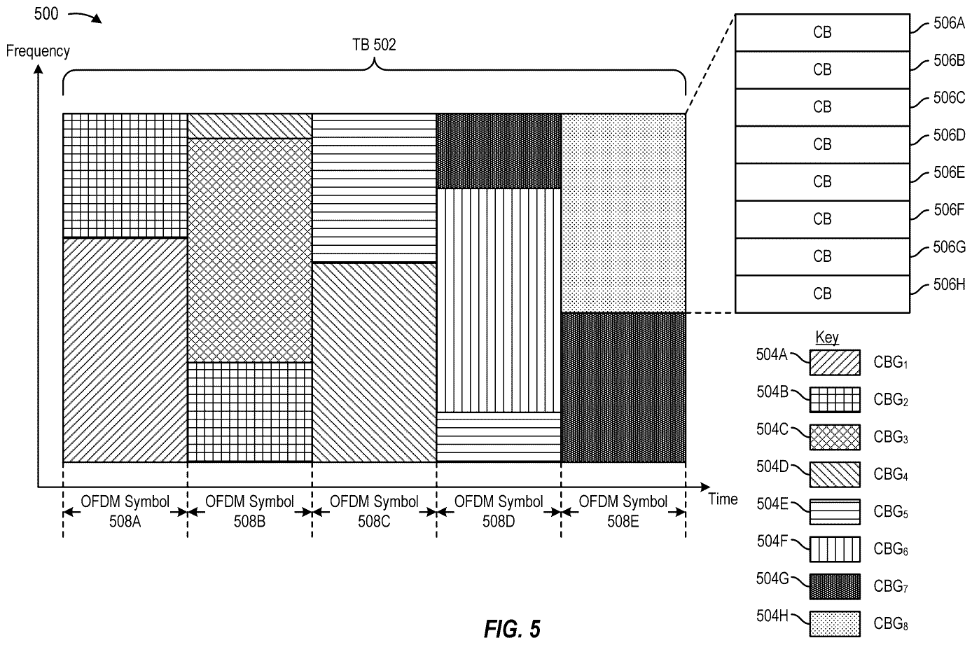

FIG. 5 depicts an example CBG partitioning scheme 500. As described previously, a device receiving a communication (e.g., a UE) may provide feedback regarding the communication, such as ACK/NACK feedback. In some aspects, the device may provide ACK/NACK feedback per CBG of a TB 502 sent by a transmitter (e.g., a network entity). For example, the TB 502 may be segmented into a plurality of CBs. Additionally, subsets of CBs of the plurality of CBs may be grouped and/or partitioned into respective CBGs 504 according to the CBG partitioning scheme 500. Subsequently, the device may attempt to decode the CBGs 504 and may provide ACK/NACK feedback per CBG. Accordingly, the transmitter may retransmit any CBGs 504 for which the device sends a NACK feedback (e.g., indicating a failed decoding of at least one CB in a corresponding CBG 504), thereby saving costly retransmissions of the entire TB 502.

In the example of FIG. 5, the CBG partitioning scheme 500 may include partitioning a plurality of CBs of a TB 502 into the respective CBGs 504. For example, a first CBG 504A (e.g., CBG₁), a second CBG 504B (e.g., CBG₂), a third CBG 504C (e.g., CBG₃), a fourth CBG 504D (e.g., CBG₄), a fifth CBG 504E (e.g., CBG₅), a sixth CBG 504F (e.g., CBG₆), a seventh CBG 504G (e.g., CBG₇), and an eighth CBG 504H (e.g., CBG₈) may be determined for the TB 502. While eight CBGs 504 are shown in the example of FIG. 5, a different number of CBGs 504 may be determined for the TB 502, where the quantity of CBGs 504 may be indicated via DCI and/or RRC signaling or another form of signaling.

As depicted in the example of FIG. 5, the CBG partitioning scheme 500 may be applied in a chronological order (e.g., frequency first). For example, the CBGs 504 may be continuous (e.g., according to CB index values), and each CBG 504 may have a same length. In the example of FIG. 5, each CBG 504 may include a length of one OFDM symbol 508. For example, the TB 502 may be sent over a first OFDM symbol 508A, a second OFDM symbol 508B, a third OFDM symbol 508C, a fourth OFDM symbol 508D, and a fifth OFDM symbol 508E, where each CBG 504 is confined to a length of an OFDM symbol 508. In some aspects, a CBG 504 may be made of CBs, and each CB may occupy one OFDM symbol 508, such that the CBG 504 may occur in multiple OFDM symbols 508 but is still made up of CBs that each occupy a single OFDM symbol 508. In some examples, the TB 502 may be split across non-contiguous OFDM symbols 508. For example, the first OFDM symbol 508A may represent an OFDM symbol 1, the second OFDM symbol 508B may represent an OFDM symbol 2, the third OFDM symbol 508C may represent an OFDM symbol 3, the fourth OFDM symbol 508D may represent an OFDM symbol after the OFDM symbol 3, and the fifth OFDM symbol 508E may represent an OFDM symbol 14. Alternatively, the OFDM symbols 508 may be contiguous in time.

Each CBG 504 may include one or more CBs. As an example, the eighth CBG 504H may include a first CB 506A, a second CB 506B, a third CB 506C, a fourth CB 506D, a fifth CB 506E, a sixth CB 506F, a seventh CB 506G, and an eighth CB 506H. Each CBG 504 may include a same quantity of CBs. In some aspects, two CBGs 504 may include different quantities of CBs. In some aspects, the size of the CBGs 504 (e.g., how many CBs are in a CBG) may be indicated via RRC signaling. The construction of each CB may also be done in a chronological way. For example, RBs may be grouped together into a CB according to the RBs' order in the frequency domain (FD)/time domain (TD) allocation of the TB 502. Thus, a CB that includes RBs that are in a “bad” part of the bandwidth allocated to the TB 502 (e.g., in a fading region associated with a low channel capacity or reliability) may have “bad” channel conditions.

In some aspects, channel condition imbalances may be overcome among different CBs by using an interleaver. With the interleaver, instead of building the CBs from RBs that are chosen in a chronological way, each CB may be built from RBs that are chosen pseudo-randomly from the whole FD/TD allocation of the TB 502. In some aspects, the interleaver may have a latency (e.g., a latency of a slot). Additionally, the RBs that are mapped together into a CB using the interleaver may have a lower probability of having channel condition imbalances. As an example, CBs that are formed using the interleaver may have a smaller MI variance than CBs that are formed chronologically. MI (e.g., measured in bits) carried over a CB may represent an indicator of a channel capacity across the different CBs of the TB 502. However, even after interleaving, the CBs may still include a range of MI values.

As described herein, the CBG partitioning scheme 500 may be applied without any consideration of channel fading levels. For example, the CBG partitioning scheme 500 may not take into consideration the channel conditions across different regions of the allocated bandwidth for the TB 502. Therefore, a CBG 504 may include CBs experiencing “good” channel conditions (e.g., high capacity and/or high MI values), as well as CBs experiencing “bad” channel conditions (e.g., low capacity and/or low MI values). As such, the CBG partitioning scheme 500 may result in a CBG 504 that has high SNR imbalances (or capacity imbalances) across its CBs, resulting in the transmitter having to retransmit the CBG 504. For example, a single CB with a poor quality and/or poor channel conditions might result in a failed reception or decoding that then results in the entire CBG 504 failing (e.g., the device sending a NACK feedback for the CBG 504) and retransmission of the entire CBG 504, whereas other CBs in the CBG 504 had good SNR and/or MI and were successfully received and decoded. As such, the retransmission of the entire CBG 504 may lead to a wasteful retransmission of the CBs that were successfully received and decoded.

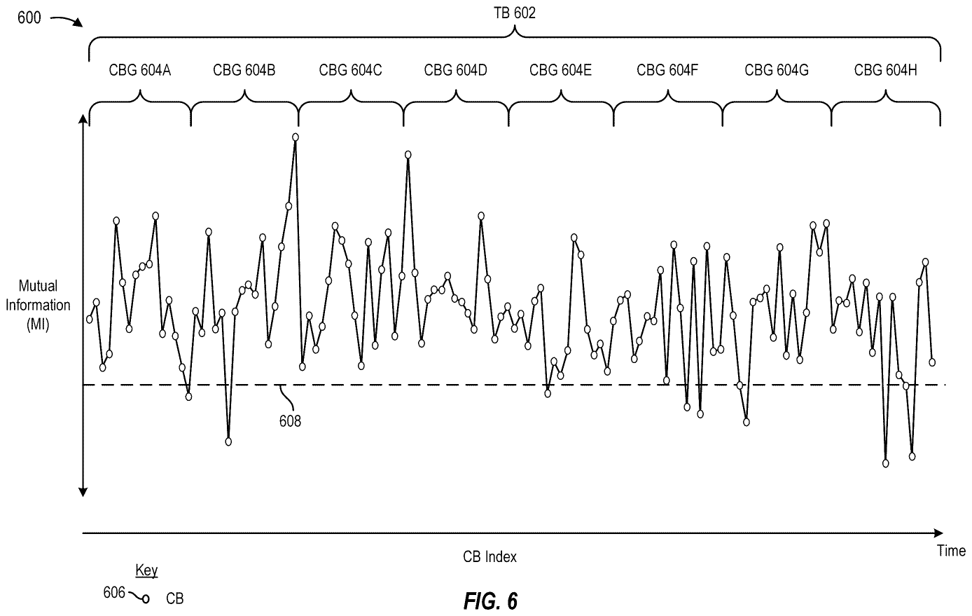

FIG. 6 depicts an example CBG partitioning scheme 600. In some aspects, the CBG partitioning scheme 600 may be similar to the CBG partitioning scheme 500 depicted and described with respect to FIG. 5. For example, the CBG partitioning scheme 600 may be applied in a chronological order for a TB 602 to form one or more CBGs 604, where each CBG 604 includes one or more CBs 606. That is, the CBs 606 may be partitioned into each CBG 604 chronologically according to index values of the CBs 606. In the example of FIG. 6, a first CBG 604A may include a first set of CBs, a second CBG 604B may include a second set of CBs, a third CBG 604C may include a third set of CBs, a fourth CBG 604D may include a fourth set of CBs, a fifth CBG 604E may include a fifth set of CBs, a sixth CBG 604F may include a sixth set of CBs, a seventh CBG 604G may include a seventh set of CBs, and an eighth CBG 604H may include an eighth set of CBs, where each set of CBs is contiguous (e.g., according to their index values). However, the CBG partitioning scheme 600 may be performed regardless of channel conditions across an allocated bandwidth for the TB 602. In some aspects, a channel's capacity for a CB 606 and/or an MI value for the CB 606 may indicate a channel condition. Thus, in the presence of a deep fading channel in a given frequency, an entire CBG 604 that includes a CB 606 that was allocated at that given frequency may have to be retransmitted.

In some aspects, an MI threshold 608 may be determined. The MI threshold 608 may represent a minimal MI value that enables and/or corresponds to a successful reception of a CB 606 at an operated modulation and coding scheme (MCS) for the TB 602. For example, if the TB 602 is sent using four layers of 256 quadrature amplitude modulation (QAM) (e.g., a modulation symbol that represents eight bits) with an MCS (e.g., data rate) of 0.75, then the MI threshold 608 may be 24 bits (e.g., 4*8*0.75=24). In some aspects, each CB 606 that is below the MI threshold 608 may be expected to fail in decoding. Thus, even if one CB 606 of a CBG 604 is below the MI threshold 608, a device attempting to decode the TB 602 may provide a NACK feedback for the corresponding CBG 604, which will result in a retransmission of the entire CBG 604. In the example of FIG. 6, the first CBG 604A, the second CBG 604B, the fifth CBG 604E, the sixth CBG 604F, the seventh CBG 604G, and the eighth CBG 604H each include at least one CB 606 that falls below the MI threshold 608. As such, the device may provide a NACK feedback for each of those CBGs 604, resulting in a retransmission of each of those CBGs 604. Accordingly, in the example of FIG. 6, 75% of the CBGs 604 of the TB 602 (e.g., six CBGs 604 out of the eight total CBGs 604) may be expected to be retransmitted due to failed decoding.

### Aspects Related to Channel-Aware CBG Partitioning

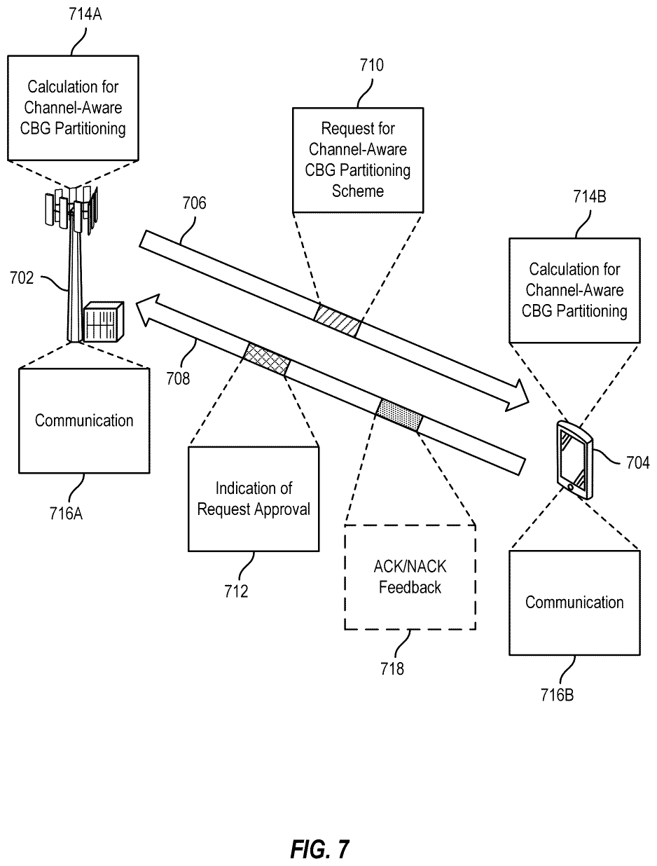

FIG. 7 depicts an example wireless communications network 700 that supports a channel-aware CBG partitioning scheme in accordance with aspects of the present disclosure. In some examples, the wireless communications network 700 may implement aspects of or may be implemented by aspects of FIGS. 1-6. For example, the wireless communications network 700 may include a network entity 702 and a UE 704. In some aspects, the network entity 702 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 704 may be an example of UE 104 depicted and described with respect to FIG. 1 or the UE 304 depicted and described with respect to FIG. 3. Additionally, the wireless communications network 700 may be an example of wireless communications network 100 and may support communication between the network entity 702 and the UE 704. For example, the network entity 702 and the UE 704 may wirelessly communicate via a communication link 706 (e.g., a downlink communication link, one or more carriers, a communication link 120, etc.) and a communication link 708 (e.g., an uplink communication link, one or more carriers, a communication link 120, etc.).

In some aspects, the network entity 702 may send a request 710 to the UE 704 (e.g., via the communication link 706) for a channel-aware CBG partitioning scheme. For example, the request 710 may include a request for the UE 704 to send ACK/NACK feedback for CBGs of a TB according to the channel-aware CBG partitioning scheme. Subsequently, the UE 704 may send an indication 712 to the network entity 702 (e.g., via the communication link 708) that indicates whether the UE 704 approves of the usage of the channel-aware CBG partitioning scheme or not. For example, the UE 704 may approve or disapprove of the usage of the channel-aware CBG partitioning scheme based on whether the UE 704 is capable of and/or supports channel-aware scenarios (e.g., whether the UE 704 is capable of determining, storing, interpreting signaling relating to, and/or measuring various parameters or conditions of a channel, such as when the UE 704 supports and/or is capable of full-duplex communications). If the indication 712 indicates that the UE 704 approves of using the channel-aware CBG partitioning scheme, then the network entity 702 and the UE 704 may use the channel-aware CBG partitioning scheme for the ACK/NACK feedback. Additionally or alternatively, if the indication 712 indicates that the UE 704 disapproves of using the channel-aware CBG partitioning scheme, then the network entity 702 and the UE 704 may use a default CBG partitioning scheme (e.g., the CBG partitioning schemes 500 and 600 depicted and described with respect to FIGS. 5 and 6, respectively) for the ACK/NACK feedback. The default CBG partitioning scheme may be referred to herein as an additional partitioning scheme.

As described herein, the wireless communications network 700 may improve (e.g., optimize) CBG partitioning of a TB by taking advantage of scenarios where the conditions of the channel can be measured and/or determined both at the network entity 702 and at the UE 704 (e.g., channel-aware scenarios, such that the CBG partitioning may be referred to as a channel-aware CBG partitioning scheme). This channel-aware CBG partitioning scheme may be especially suitable to a frequency range 3 (FR3) (e.g., 7.125 GHz-24.25 GHz), where the channel is evaluated at a high rate due to the usage of advanced configurations, such as full-duplex communications (e.g., when the UE 704 supports or is capable of full-duplex communications). Subsequently, based on the techniques and signaling described with reference to the wireless communications network 700, a CBG partitioning may be performed with respect to a given channel's capacity (or MI) at given FD/TD REs that are in a CB so that each CBG contains CBs in a same range such as with closest capacities (e.g., similar MI values) rather than partitioning CBs into CBGs chronologically as described with reference to FIGS. 5 and 6. Using the channel-aware CBG partitioning scheme, the size of the CBGs may not be necessarily identical (e.g., the CBGs may not necessarily include a same quantity of CBs). Additionally, with the channel-aware CBG partitioning scheme, the CBGs may not be necessarily contiguous across a time duration (e.g., across a FD/TD allocation for the TB). In some aspects, the mapping to CBs and/or the rate matching may not be changed for the channel-aware CBG partitioning scheme compared to the CBG partitioning schemes 500 and 600 depicted and described with respect to FIGS. 5 and 6, respectively.

If the channel-aware CBG partitioning scheme is approved to be used (e.g., via the indication 712), the network entity 702 may perform a calculation 714A for the channel-aware CBG partitioning scheme, and the UE 704 may also perform a calculation 714B for the channel-aware CBG partitioning scheme. One example of evaluating the channel's capacity in every CB (e.g., based on a determination and/or measurement of channel conditions for each CB) may be performed for the calculations 714A and 714B using Teletar's capacity expression as given below in Equation 1:

$${C}_{i} = {\sum }_{k ∈ C {B}_{i}} {log}_{2} \vert {I}_{Nss \times Nss} + {H}_{k}^{H} {R}_{n n}^{- 1} {H}_{k} \vert \qquad ( 1 )$$

Cᵢ may represent the channel capacity of the i^{th} CB (e.g., CBᵢ); I may represent the identity matrix; Nss may represent a number of transmitted streams; Rₙₙ may represent the downlink noise's autocovariance matrix; and Hₖ may represent the channel at the k^{th} RE which is determined and/or measured at both the network entity 702 and the UE 704. Accordingly, Equation 1 may represent a summation of the capacities at all the REs that belong to the i^{th} CB.

In some aspects, the UE 704 may indicate the Rₙₙ to the network entity 702 according to an estimation performed by the UE 704. For example, the UE 704 may send an indication when Rₙₙ is changed to provide the network entity 702 the capability to calculate Equation 1 and apply the channel-aware CBG partitioning scheme. If the network entity 702 and/or the UE 704 decide on any other metric for applying the channel-aware CBG partitioning scheme (e.g., other than channel capacity), where the other metric uses other indications, those indications may be sent over the communication link 706 or the communication link 708. After evaluating the capacity for all of the CBs, the network entity 702 and/or the UE 704 may sort the CBs from the highest capacity to the lowest capacity.

The channel-aware CBG partitioning scheme may be changed based on a chosen policy indicated by a given network entity 702. For example, another option for implementing the channel-aware CBG partitioning scheme may be based on thresholds. As an example, all CBs whose channel capacity is greater than a first threshold (TH1) may be grouped to a first CBG, all CBs whose capacity is smaller than the first threshold but greater than a second threshold (TH2) may be grouped to a second CBG, etc. Accordingly, the network entity 702 may inform on its channel aware CBG partitioning at the beginning of communications with the UE 704 (e.g., when sending the request 710) and when the network entity 702 changes the chosen policy for the channel-aware CBG partitioning scheme. Subsequently, the network entity 702 and the UE 704 may perform the calculation 714 to calculate a metric corresponding to or representing channel conditions (e.g., MI per CB, channel capacity, etc.) and may group the CBs into CBGs according to the chosen policy indicated by the network entity 702. In some aspects, another metric (e.g., instead of channel capacity or MI) that corresponds to or represents channel conditions may be used for the channel-aware CBG partitioning scheme, such as channel strength, SNR, etc. In any chosen metric and/or policy by the network entity 702, the CBG partitioning may be dependent on the channel conditions, and the channel conditions may be assumed to be determined (e.g., measured) at both the network entity 702 and the UE 704 (e.g., channel aware) due to reciprocity and/or channel reports.

Using the channel-aware CBG partitioning scheme, each CBG may be associated with a uniform SNR and/or channel capacity level (with respect to CBs of a CBG). Additionally, different CBGs may have different levels of quality (e.g., SNR, channel capacity, etc.), such that CBGs with high SNR and/or channel capacity levels are less likely to have decoding failures for any CBs in those CBGs. That is, it may be less likely that the UE 704 fails to receive and/or decode a single CB of a high quality CBG (e.g., the CBGs with high SNR and/or channel capacity levels).

However, in some aspects, channel mismatches between the network entity 702 and the UE 704 may lead to a different CBG partitioning at the network entity 702 and at the UE 704, which might cause a faulty retransmission in the case of failed decoding. That is, each of the network entity 702 and the UE 704 may capture a channel that is slightly different than what is captured from the other device. To validate that the partitioning decision is the same at both the network entity 702 and the UE 704, the UE 704 may send a redundancy check (e.g., using cyclic redundancy check (CRC) bits) over an updated CBG partitioning map upon a change in the partitioning (e.g., based on variations of the channel). For example, CB indices for each transmitted CBG may be concatenated with one another, and then this concatenated index list may be input to a CRC calculator to yield a set of CRC bits. The network entity 702 may perform the same CRC calculation and compare its calculation of CRC bits to a received message from the UE 704 that includes the redundancy check. If there are any CRC mismatches, the network entity 702 may retransmit the entirety of the CBs of the TB (e.g., may fallback to a legacy mode of retransmitting the entire TB).

To prevent CBG partitioning mismatches at both the network entity 702 and the UE 704 (or at least to lower the probability that the CBG partitioning mismatches happen), some conservative constraints may be used. For example, the UE 704 and/or the network entity 702 may perform an evaluation of channel conditions (e.g., as well as an estimated noise at the UE 704) and may update the channel conditions (along with the corresponding CBG partitioning) periodically (e.g., once every several slots according to a periodicity such as an SRS periodicity). In some aspects, the network entity 702 may indicate to the UE 704 a slot number that the channel conditions were evaluated upon (e.g., from the SRS) and a periodicity referred to as an updating periodicity, and the UE 704 and/or the network entity 702 may perform the evaluation of the channel conditions accordingly from the same slot number and at the same periodicity. For example, the Thus, channel mismatches may be mitigated because the network entity 702 and the UE 704 may refer to a same channel, even if the channel is outdated. In some aspects, the UE 704 and/or the network entity 702 may perform the evaluation of channel conditions using Equation 1 provided previously or other channel estimation calculations to derive the channel conditions.

Additionally or alternatively, thresholds for the chosen metric and/or policy (e.g., MI thresholds) between different CBGs may be determined in a more conservative form with a threshold parameter than the constraints described previously. For example, in the case of MI as a chosen metric for the channel-aware CBG partitioning scheme, CBs that belong to different CBGs may have at least a threshold quantity of bits for an MI gap between the CBs. That is, for MI values per CB (after sorting), an MI gap of at least the threshold quantity of bits between CBs may indicate when a new CBG starts. As an example, the threshold quantity of bits for the MI gap may be 0.5 bits. In this example, a first CBG may include four CBs that have MI values of 23.00, 23.20, 22.90, and 22.80, respectively; a second CBG may include six CBs that have MI values of 25.00, 24.90, 24.80, 24.78, 24.70, and 24.60, respectively; and a third CBG may include four CBs that have MI values of 26.00, 25.90, 25.90, and 25.60, respectively. Accordingly, each of the CBs in each CBG may have an MI gap between CBs that is less than the threshold quantity of bits, but CBs in different CBGs may be separated by an MI gap that is greater than or equal to the threshold quantity of bits. That is, the MI gap between a CB with the highest MI value in the first CBG (e.g., 23.00) and a CB with the lowest MI value in the second CBG (e.g., 24.60) may include at least the threshold quantity of bits, and the MI gap between a CB with the highest MI value in the second CBG (e.g., 25.00) and a CB with the lowest MI value in the third CBG (e.g., 25.60) may also include at least the threshold quantity of bits. The threshold quantity of bits for the MI gap of 0.5 bits is understood to be an example, and other values for the threshold quantity of bits may be used.

Using the threshold quantity of bits for the MI gap between CBGs may ensure that even if there is a channel mismatch, the probability of the boundary CBG toggling between adjacent CBGs may be negligible. As such, the probability of both the network entity 702 and the UE 704 concluding of the same CBG partitioning (e.g., even under channel mismatches) may become better and/or higher. In some aspects, if an MI variance (per CB) across the TB is smaller than a threshold quantity bits, then the CBG partitioning may be performed based on the CBG partitioning scheme 500 or the CBG partitioning scheme 600 as described with reference to FIGS. 5 and 6, respectively (e.g., the CBs are partitioned into the CBGs chronologically and not based on channel conditions). The thresholds described above may be shared as part of the chosen policy indicated by the network entity 702 for the channel-aware CBG partitioning scheme. The constraints described above may represent examples. That is, the network entity 702 may decide to use a different policy to handle channel mismatches that are not expressly listed herein.

After the channel-aware CBG partitioning scheme is employed and validated, the network entity 702 may perform communications 716A, and the UE 704 may perform communications 716B. For example, as part of the communications 716A and 716B, the UE 704 may send ACK/NACK feedback 718 to the network entity 702 (e.g., via the communication link 708). As an example, in the case of a CB that was failed to be received and/or decoded, the UE 704 may indicate a NACK for the corresponding CBG according to the channel-aware CBG partitioning scheme in the ACK/NACK feedback 718, and the network entity 702 may retransmit the corresponding CBG to the UE 704.

In some aspects, the network entity 702 and/or the UE 704 may request to update the channel-aware CBG partitioning scheme. For example, the network entity 702 and/or the UE 704 may transmit a request to update the channel-aware CBG partitioning scheme due to channel aging, SNR changing, configuration changing, interference or blocking scenarios, etc. The request to update the channel-aware CBG partitioning scheme may be aperiodic or periodic, for example, according to a policy for the network entity 702 and the UE 704. In some aspects, the request to update the channel-aware CBG partitioning scheme may indicate to stop the channel-aware CBG partitioning scheme. Subsequently, a recipient of the request (e.g., the network entity 702 or the UE 704) may approve or disapprove the request to update the channel-aware CBG partitioning scheme. If the request is approved, the calculations 714A and 714B may occur again. Subsequently, the UE 704 may send an additional indication if the network entity 702 needs additional information for the calculation 714A. The application of the channel-aware CBG partitioning scheme occurs again with the updates included.

In some aspects, while a network entity 702 is described as sending a TB and a UE 704 is described as sending the ACK/NACK feedback in the example of FIG. 7, other types of devices may perform either operation.

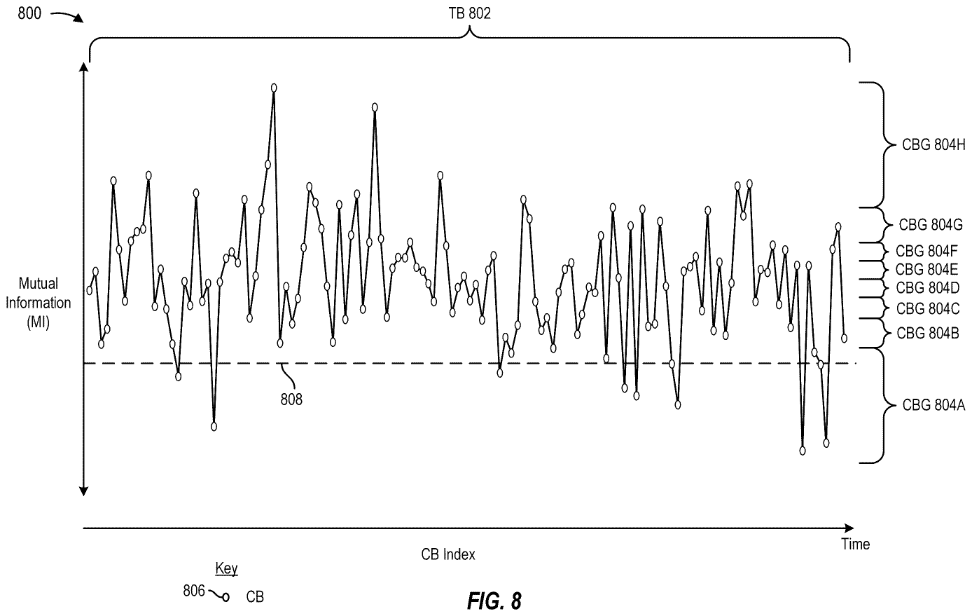

FIG. 8 depicts an example channel-aware CBG partitioning scheme 800 in accordance with aspects of the present disclosure. In some examples, the channel-aware CBG partitioning scheme 800 may implement aspects of or may be implemented by aspects of FIGS. 1-7. For example, the channel-aware CBG partitioning scheme 800 may represent an example of the channel-aware CBG partitioning scheme based on channel conditions as described with reference to FIG. 7.

In the example of FIG. 8, the channel-aware CBG partitioning scheme 800 may be applied based on MI values of one or more CBs 806 of a TB 802 to form one or more CBGs 804. That is, the CBs 806 may be partitioned into each CBG 804 based on MI values of the CBs 806. In the example of FIG. 8, a first CBG 804A may include a first set of CBs, a second CBG 804B may include a second set of CBs, a third CBG 804C may include a third set of CBs, a fourth CBG 804D may include a fourth set of CBs, a fifth CBG 804E may include a fifth set of CBs, a sixth CBG 804F may include a sixth set of CBs, a seventh CBG 804G may include a seventh set of CBs, and an eighth CBG 804H may include an eighth set of CBs, where each set of CBs have similar channel conditions (e.g., MI values within configured threshold values). While MI values are used for the channel-aware CBG partitioning scheme 800, other chosen metrics and/or policies may be used to partition the CBs 806 into the one or more CBGs 804.

In some aspects, an MI threshold 808 may be determined. The MI threshold 808 may represent the MI threshold 608 depicted and described with respect to FIG. 6. In some aspects, each CB 806 that is below the MI threshold 808 may be expected to fail in decoding. Thus, even if one CB 806 of a CBG 804 is below the MI threshold 808, a device attempting to decode the TB 802 (e.g., a UE) may provide a NACK feedback for the corresponding CBG 804, which will result in a retransmission of the entire CBG 804. In the example of FIG. 8, the first CBG 804A includes at least one CB 806 that falls below the MI threshold 808. As such, the device may provide a NACK feedback for the first CBG 804A, resulting in a retransmission of the first CBG 804A. Accordingly, in the example of FIG. 8, 12.5% of the CBGs 804 of the TB 802 (e.g., one CBG 804 out of the eight total CBGs 804) may be expected to be retransmitted due to failed decoding. As such, the channel-aware CBG partitioning scheme 800 may represent an improvement compared to the CBG partitioning scheme 600 depicted and described with respect to FIG. 6, where 75% of the CBGs 604 were expected to be retransmitted due to failed decoding (e.g., the channel-aware CBG partitioning scheme 800 prevents retransmission of 62.5% of a TB compared to the CBG partitioning scheme 600).

### Example Signaling for Channel-Aware CBG Partitioning

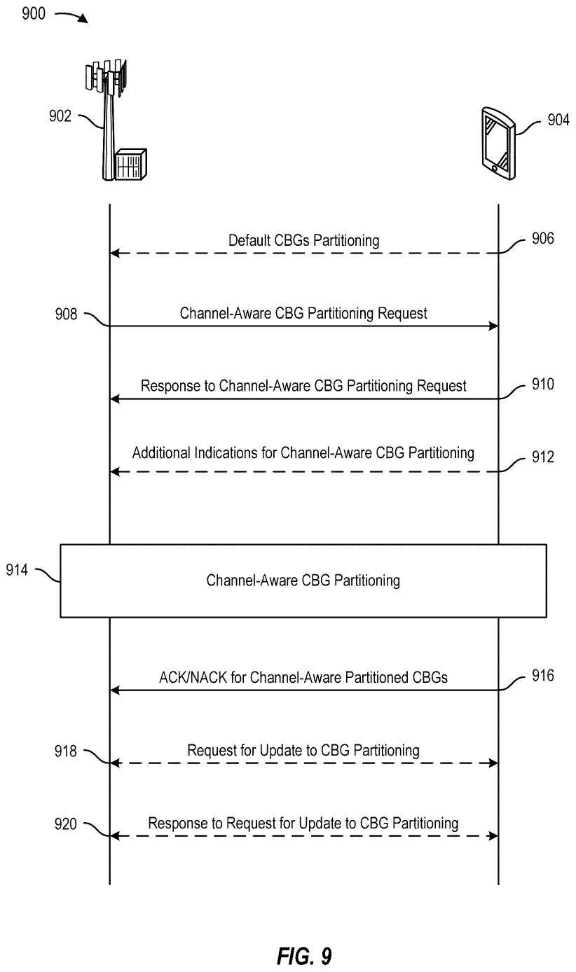

FIG. 9 depicts an example process flow for communications in a network between a network entity 902 and a UE 904. In some aspects, the network entity 902 may be an example of the BS 102 depicted and described with respect to FIG. 1, the first network entity 300 or the second network entity 302 depicted and described with respect to FIG. 3, a disaggregated base station depicted and described with respect to FIG. 2, or a network entity 702 depicted and described with respect to FIG. 7. Similarly, the UE 904 may be an example of UE 104 depicted and described with respect to FIG. 1, the UE 304 depicted and described with respect to FIG. 3, or the UE 704 depicted and described with respect to FIG. 7. However, in other aspects, UE 904 may be another type of wireless communications device and network entity 902 may be another type of network entity or network node, such as those described herein. Note that any operations or signaling illustrated with dashed lines may indicate that that operation or signaling is an optional or alternative example.

At 906, the network entity 902 and the UE 904 optionally communicate according to a default CBG partitioning (e.g., the CBG partitioning scheme 500 and/or the CBG partitioning scheme 600 depicted and described with reference to FIGS. 5 and 6, respectively). For example, before calculation of capacity of various CBs or the channel, the UE 904 may have no other preferable partitioning option.

At 908, the network entity 902 sends and the UE 904 obtains a request for a partitioning scheme for a plurality of CBGs of a TB (e.g., the request 710 depicted and described with respect to FIG. 7), where the partitioning scheme indicates a partitioning of a plurality of CBs of the TB into the plurality of CBGs based on a channel condition for transmission of the TB. In some aspects, the network entity 902 may send and the UE 904 may obtain the request for the partitioning scheme via a MAC control element (CE). For example, the request may occur at the beginning of communications between the network entity 902 and the UE 904 (e.g., upon attachment or RRC connection establishment) over the MAC-CE. Additionally, the partitioning scheme may include a channel-aware partitioning scheme for the partitioning of the plurality of CBs into the plurality of CBGs (e.g., the channel-aware CBG partitioning scheme 800 depicted and described with respect to FIG. 8). That is, the network entity 902 sends a request to the UE 904 over downlink to send ACK/NACK indications according to the channel-aware CBG partitioning scheme.

In some aspects, the network entity 902 may send, and the UE 904 may obtain, an indication of a chosen policy for the partitioning scheme. For example, the network entity 902 may send and the UE 904 may obtain the indication of the chosen policy in the request. That is, the network entity 902 may add the chosen policy to the request, where the chosen policy is based on the channel condition (e.g., a chosen metric, a chosen partition rule, etc.). In some aspects, the chosen policy may indicate a configuration for the plurality of CBGs for the partitioning scheme based on one or more of: a respective channel capacity for each CB of the plurality of CBs of the TB, respective mutual information values for each CB, respective SNR values for each CB, respective signal strength measurements for each CB, or another metric that represents the channel condition for each CB. In some aspects, the network entity 902 may send and the UE 904 may obtain, in the indication of the chosen policy, one or more threshold values for the configuration for the plurality of CBGs for the partitioning scheme.

At 910, the UE 904 sends and the network entity 902 obtains an indication of whether the request is approved by the UE 904 (e.g., the indication 712 depicted and described with respect to FIG. 7). For example, the UE 904 may approve or disapprove the request for the partitioning scheme based on whether the UE 904 is capable of and/or supports channel-aware scenarios, such as being capable of and/or supporting full-duplex communications. In some aspects, the indication may include an approval for the request. Subsequently, the UE 904 may send and the network entity 902 may obtain information indicating a slot at which the UE 904 will begin to use the partitioning scheme. The indication of the slot may be based on a calculation latency of the chosen metric at the UE 904. Additionally or alternatively, the indication may include a disapproval for the request. That is, the UE 904 may approve or disapprove the request and may send the indication over the uplink (e.g., at the beginning of the communication, upon attachment, over a MAC-CE). Additionally, if the UE 904 approves the request, the UE 904 and the network entity 902 may start applying the partitioning scheme (e.g., the channel-aware CBG partitioning scheme) at or after 910 (e.g., based on the indication of the slot at which the UE 904 will begin to use the partitioning scheme).

At 912, the UE 904 may send and the network entity 902 may obtain an indication of one or more parameters for determination of the partitioning of the plurality of CBs into the plurality of CBGs according to the partitioning scheme. In some aspects, the UE 904 may send and the network entity 902 may obtain the indication of the one or more parameters via a physical uplink channel. That is, the UE 904 may send one or more additional indications for calculating the chosen metric and/or policy that is used and/or indicated for the partitioning scheme, and those additional indication(s) may be sent over the PHY level interface (e.g., a physical uplink control channel (PUCCH) as part of uplink control information (UCI)). For example, if the chosen metric and/or policy is capacity-based, the UE 904 may send an indication of Ren to the network entity 902.

At 914, the network entity 902 and the UE 904 apply the partitioning scheme (e.g., channel-aware CBG partitioning scheme) if the UE 904 approves the request. That is, the network entity 902 and the UE 904 may perform a same calculation for the channel-aware CBG partitioning scheme (e.g., the calculations 714A and 714B depicted and described with respect to FIG. 7) according to the chosen metric and/or policy that was informed at 908. In some aspects, the plurality of CBGs may include a first CBG and a second CBG. Accordingly, the first CBG may include a first set of CBs (e.g., of the plurality of CBs in the TB) that have a metric corresponding to the channel condition in a first range, and the second CBG may include a second set of CBs (e.g., of the plurality of CBs in the TB) that have the metric in a second range. In some aspects, the first range may indicate a better channel condition than the second range. In some aspects, the first range and the second range may be non-overlapping with one another. In some aspects, the first set of CBs may be non-contiguous with one another in time, and/or the second set of CBs may be non-contiguous with one another in time. In some aspects, a first quantity of CBs in the first set of CBs may be different than a second quantity of CBs in the second set of CBs.

In some aspects, the network entity 902 and the UE 904 may perform a redundancy check for the plurality of CBGs after a determination of the partitioning of the plurality of CBs into the plurality of CBGs according to the partitioning scheme. For example, the redundancy check may be performed as described with reference to FIG. 7 for mitigating channel mismatches and validating the partitioning decision is the same at both the network entity 902 and the UE 904. In some aspects, the network entity 902 may send and the UE 904 may obtain an indication of a slot number and a periodicity for which the network entity 902 evaluated the channel condition for determination of the partitioning of the plurality of CBs into the plurality of CBGs according to the partitioning scheme. Subsequently, the UE 904 may perform an evaluation of the channel condition (e.g., using Equation 1 provided previously and/or other channel estimation calculations) for the determination of the partitioning of the plurality of CBs into the plurality of CBGs according to the partitioning scheme based on the indication of the slot number and the periodicity.

At 916, the network entity 902 and the UE 904 communicate (e.g., the communications 716A and 716B depicted and described with respect to FIG. 7) in accordance with the partitioning scheme. For example, if the indication communicated at 910 includes an approval for the request, the network entity 902 and the UE 904 may communicate according to the partitioning scheme in accordance with the approval. As an example of the communications between the network entity 902 and the UE 904, the UE 904 may send and the network entity 902 may obtain acknowledgment feedback (e.g., the ACK/NACK feedback 718 depicted and described with respect to FIG. 7) for each CBG of the plurality of CBGs. That is, the UE 904 may transmit an ACK/NACK feedback indication according to the channel aware CBGs partitioning that was calculated at 914.

Alternatively, if the indication communicated at 910 includes a disapproval for the request, the network entity 902 and the UE 904 may communicate according to an additional partitioning scheme (e.g., the default CBG partitioning used at 906, such as the CBG partitioning scheme 500 and/or the CBG partitioning scheme 600 depicted and described with reference to FIGS. 5 and 6, respectively) in accordance with the disapproval. For example, the additional partitioning scheme may correspond to an additional partitioning of the plurality of CBs into the plurality of CBGs irrespective of the channel condition (e.g., the additional partitioning scheme may be referred to as a default partitioning scheme as described herein).

In some aspects, the network entity 902 may send and the UE 904 may obtain a second request for a second partitioning scheme for a second plurality of CBGs of a second TB. In such aspects, the second partitioning scheme may indicate a second partitioning of a second plurality of CBs into the second plurality of CBGs based on a second channel condition for transmission of the second TB. However, the UE 904 may send and the network entity 902 may obtain an indication that the second request is disapproved. Accordingly, the network entity 902 and the UE 904 may communicate in accordance with the additional partitioning scheme based on the second request being disapproved. In such aspects, the additional partitioning scheme includes an additional partitioning of the second plurality of CBs into an additional plurality of CBGs irrespective of the second channel condition.

At 918, the UE 904 may send and the network entity 902 may obtain an additional request to update the partitioning scheme. Additionally or alternatively, the network entity 902 may send and the UE 904 may obtain the additional request to update the partitioning scheme. That is, the UE 904 and/or the network entity 902 may request to update the channel-aware CBG partitioning (e.g., due to channel aging, SNR changing, configuration changing, interference or blocking scenarios, etc.). In some aspects, the additional request may be aperiodic or periodic (e.g., according to each network entity-UE pair policy). In some aspects, the additional request may indicate that the UE 904 and/or the network entity 902 want to stop the channel-aware CBG partitioning.

At 920, the network entity 902 may send and the UE 904 may obtain an approval indication for the additional request. Additionally or alternatively, the UE 904 may send and the network entity 902 may obtain the approval indication for the additional request. That is, a recipient of the additional request (e.g., the UE 904 and/or the network entity 902) may approve or disapprove the additional request. If the additional request is approved, the network entity 902 and the UE 904 may perform the operations at 912, 914, and 916 again. For example, the UE 904 may send an additional indication if the network entity 902 needs additional information for the updated partitioning scheme, and the mutual channel-aware CBG partitioning calculation and application of the channel-aware CBG partitioning scheme may occur again.

Note that the process flow illustrated in FIG. 9 is an example of signaling for a CBG partitioning scheme, and aspects of the present disclosure may be applied to a channel-aware CBG partitioning scheme. Note that the process flow illustrated in FIG. 9 is described herein to facilitate an understanding of signaling for a channel-aware CBG partitioning scheme, and aspects of the present disclosure may be performed in various manners via alternative or additional signaling and/or operations. In certain aspects, the operations and/or signaling of FIG. 9 may occur in an order different from that described or depicted, and various actions, operations, and/or signaling may be added, omitted, or combined.

### Example Operations of a User Equipment

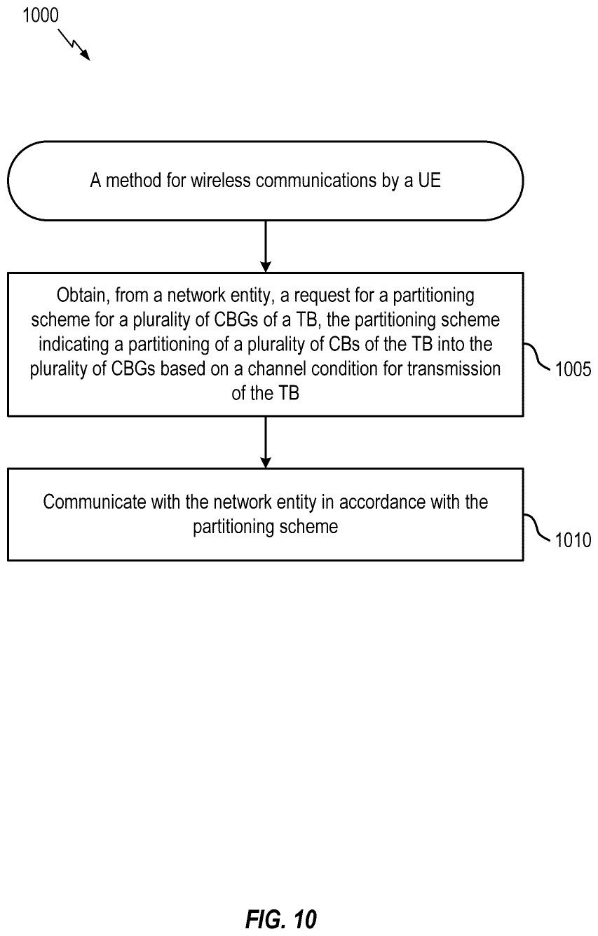

FIG. 10 shows a method 1000 for wireless communications by an apparatus, such as UE 104 of FIG. 1 or UE 304 of FIG. 3.

Method 1000 begins at block 1005 with obtaining, from a network entity, a request for a partitioning scheme for a plurality of CBGs of a TB (e.g., the request 710 depicted and described with respect to FIG. 7), the partitioning scheme indicating a partitioning of a plurality of CBs of the TB into the plurality of CBGs based on a channel condition for transmission of the TB.

Method 1000 then proceeds to block 1010 with communicating (e.g., the communications 716A and 716B depicted and described with respect to FIG. 7) with the network entity in accordance with the partitioning scheme.

In some aspects, method 1000 further includes obtaining, from the network entity, an indication of a chosen policy for the partitioning scheme, wherein the chosen policy indicates a configuration the partitioning of the plurality of CBs into the plurality of CBGs for the partitioning scheme.

In some aspects, method 1000 further includes obtaining the indication of the chosen policy in the request.

In some aspects, the chosen policy indicates the configuration for the partitioning of the plurality of CBs into the plurality of CBGs for the partitioning scheme (e.g., the calculations 714A and 714B depicted and described with respect to FIG. 7) based on one or more of: a respective channel capacity for each CB of the plurality of CBs of the TB, respective mutual information values for each CB, respective SNR values for each CB, respective signal strength measurements for each CB, or another metric that represents the channel condition for each CB.

In some aspects, method 1000 further includes obtaining, in the indication of the chosen policy, one or more threshold values for the configuration for the partitioning of the plurality of CBs into the plurality of CBGs for the partitioning scheme.

In some aspects, method 1000 further includes sending, to the network entity, an indication of whether the request is approved (e.g., the indication 712 depicted and described with respect to FIG. 7).

In some aspects, the indication comprises an approval for the request, and the method 1000 further comprises communicating with the network entity according to the partitioning scheme in accordance with the approval.

In some aspects, method 1000 further includes sending, to the network entity, information indicating a slot at which the UE will begin to use the partitioning scheme.

In some aspects, method 1000 further includes obtaining, from the network entity, a second request for a second partitioning scheme for a second plurality of CBGs of a second TB, the second partitioning scheme indicating a second partitioning of a second plurality of CBs into the second plurality of CBGs based on a second channel condition for transmission of the second TB.

In certain aspects, the method 1000 further includes sending, to the network entity, an indication that the second request is disapproved.

In certain aspects, the method 1000 further includes communicating with the network entity in accordance with an additional partitioning scheme based on the second request being disapproved, the additional partitioning scheme comprising an additional partitioning of the second plurality of CBs into an additional plurality of CBGs irrespective of the second channel condition

In some aspects, method 1000 further includes sending, to the network entity, an indication of one or more parameters for determination of the partitioning of the plurality of CBs into the plurality of CBGs according to the partitioning scheme.

In some aspects, method 1000 further includes sending the indication of the one or more parameters via a physical uplink channel.

In some aspects, block 1010 includes sending, to the network entity, acknowledgment feedback for each CBG of the plurality of CBGs (e.g., the ACK/NACK feedback 718 depicted and described with respect to FIG. 7).

In some aspects, method 1000 further includes sending, to the network entity, an additional request to update the partitioning scheme.

In some aspects, method 1000 further includes obtaining, from the network entity, an approval indication for the additional request.

In some aspects, method 1000 further includes obtaining, from the network entity, an additional request to update the partitioning scheme.

In some aspects, method 1000 further includes sending, to the network entity, an approval indication for the additional request.

In some aspects, method 1000 further includes performing a redundancy check with the network entity for the plurality of CBGs after a determination of the partitioning of the plurality of CBs into the plurality of CBGs according to the partitioning scheme.

In some aspects, method 1000 further includes obtaining, from the network entity, an indication of a slot number and a periodicity for which the network entity evaluated the channel condition for determination of the partitioning of the plurality of CBs into the plurality of CBGs according to the partitioning scheme.

In some aspects, method 1000 further includes performing an evaluation of the channel condition for the determination of the partitioning of the plurality of CBs into the plurality of CBGs according to the partitioning scheme based on the indication of the slot number and the periodicity.

In some aspects, method 1000 further includes obtaining the request for the partitioning scheme via a MAC-CE.

In some aspects, the partitioning scheme comprises a channel-aware partitioning scheme for the plurality of CBGs.

In some aspects, the plurality of CBGs comprises a first CBG and a second CBG, the first CBG comprises a first set of CBs that have a metric corresponding to the channel condition in a first range, and the second CBG comprises a second set of CBs that have the metric in a second range.

In some aspects, the first range indicates a better channel condition than the second range.

In some aspects, the first range and the second range are non-overlapping.

In some aspects, the first set of CBs are non-contiguous with one another in time, the second set of CBs are non-contiguous with one another in time, or both.

In some aspects, a first quantity of CBs in the first set of CBs is different than a second quantity of CBs in the second set of CBs.

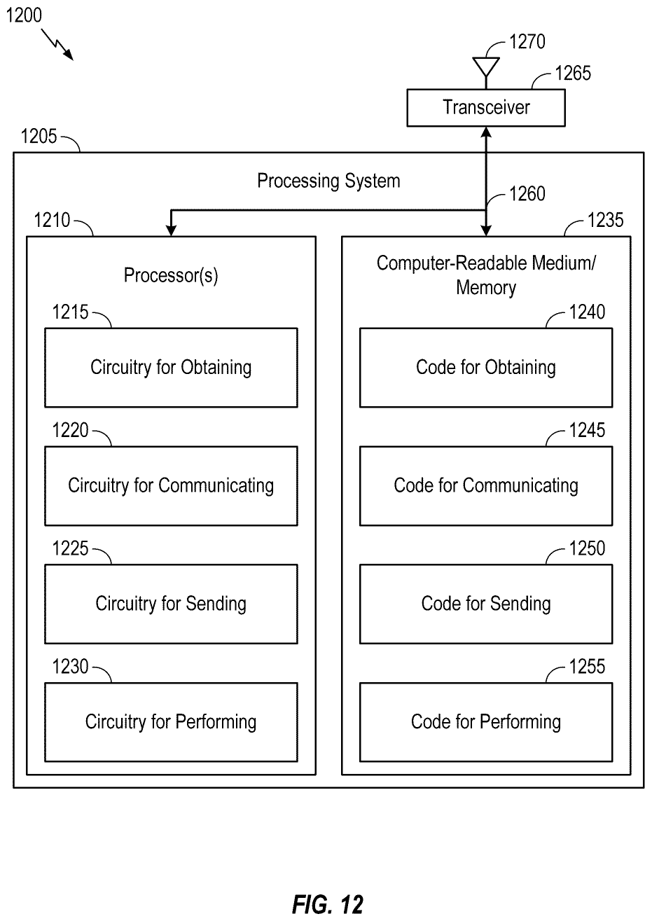

In some aspects, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

In certain aspects, method 1000 may be performed by the apparatus to realize one or more technical effects or solutions to the aforementioned technical problem(s). For example, based on method 1000, the techniques for employing a channel-aware CBG partitioning scheme may reduce the number of CBGs that are retransmitted, thereby reducing signaling overhead and reducing channel usage. Additionally, the apparatus may choose between the channel-aware CBG partitioning scheme and the default partitioning scheme (e.g., based on approving or not approving the channel-aware CBG partitioning scheme), which may increase a reliability of successfully receiving the TB if the channel-aware CBG partitioning scheme is not supported and/or approved. In some aspects, the channel-aware CBG partitioning scheme may partition CBs that experience “bad” channel conditions into same CBG(s) and CBs that experience “good” channel conditions into same CBG(s). Accordingly, the CBs that experience the “bad” channel conditions may be confined to a small quantity of CBGs rather than being distributed across a higher quantity of the CBGs. Subsequently, the second device may send NACK feedback indication(s) for the small quantity of CBGs that include the CBs that experience the “bad” channel conditions (e.g., CBs that are unsuccessfully received by the second device), and the first device may retransmit those CBGs, which may be a smaller quantity of CBGs compared to when the CBs are partitioned to CBGs irrespective of the channel condition. As such, the retransmissions may include fewer CBs that were successfully received previously at the second device, thereby reducing wasteful retransmissions.

### Example Operations of a Network Entity

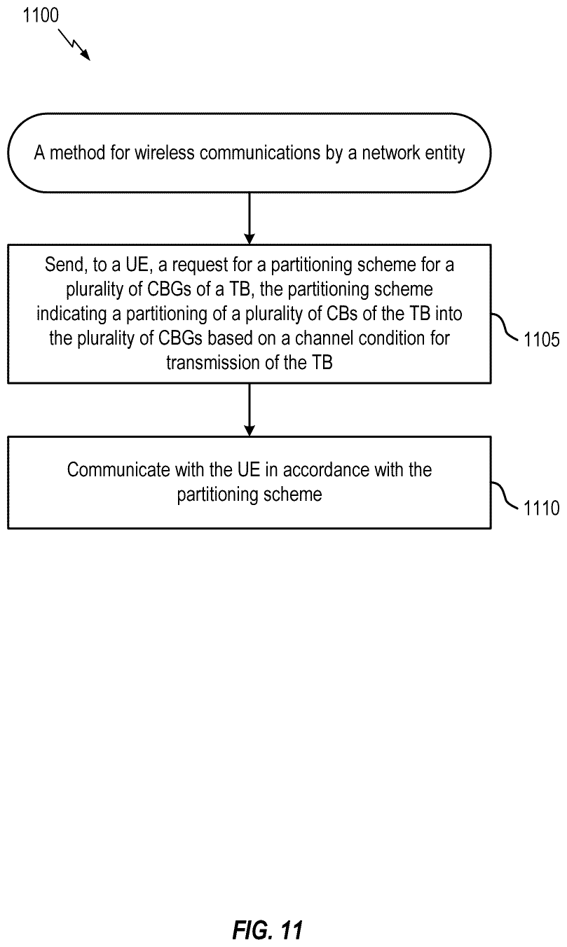

FIG. 11 shows a method 1100 for wireless communications by an apparatus, such as BS 102 of FIG. 1, a first network entity 300 or second network entity 302 of FIG. 3, or a disaggregated base station as discussed with respect to FIG. 2.

Method 1100 begins at block 1105 with sending, to a UE, a request for a partitioning scheme for a plurality of CBGs of a TB (e.g., the request 710 depicted and described with respect to FIG. 7), the partitioning scheme indicating a partitioning of a plurality of CBs into the plurality of CBGs based on a channel condition for transmission of the TB.

Method 1100 then proceeds to block 1110 with communicating (e.g., the communications 716A and 716B depicted and described with respect to FIG. 7) with the UE in accordance with the partitioning scheme.

In certain aspects, method 1100 further includes sending, to the UE, an indication of a chosen policy for the partitioning scheme, wherein the chosen policy indicates a configuration for the partitioning of the plurality of CBs into the plurality of CBGs for the partitioning scheme.

In certain aspects, method 1100 further includes sending the indication of the chosen policy in the request.

In some aspects, the chosen policy indicates the configuration for the partitioning of the plurality of CBs into the plurality of CBGs for the partitioning scheme (e.g., the calculations 714A and 714B depicted and described with respect to FIG. 7) based on one or more of: a respective channel capacity for each CB of the plurality of CBs of the TB, respective mutual information values for each CB, respective SNR values for each CB, respective signal strength measurements for each CB, or another metric that represents the channel condition for each CB.

In certain aspects, method 1100 further includes sending, in the indication of the chosen policy, one or more threshold values for the configuration for the partitioning of the plurality of CBs into the plurality of CBGs for the partitioning scheme.

In certain aspects, method 1100 further includes obtaining, from the UE, an indication of whether the request is approved (e.g., the indication 712 depicted and described with respect to FIG. 7).

In some aspects, the indication comprises an approval for the request, and the method 1100 further comprises communicating with the UE according to the partitioning scheme in accordance with the approval.

In certain aspects, method 1100 further includes obtaining, from the UE, information indicating a slot at which the UE will begin to use the partitioning scheme.

In some aspects, the method 1100 further includes sending, to the UE, a second request for a second partitioning scheme for a second plurality of CBGs of a second TB, the second partitioning scheme indicating a second partitioning of a second plurality of CBs into the second plurality of CBGs based on a second channel condition for transmission of the second TB.

In certain aspects, the method 1100 further includes obtaining, from the UE, an indication that the second request is disapproved.

In certain aspects, the method 1100 further includes communicating with the UE in accordance with an additional partitioning scheme based on the second request being disapproved, the additional partitioning scheme comprising an additional partitioning of the second plurality of CBs into an additional plurality of CBGs irrespective of the second channel condition.

In some aspects, method 1100 further includes obtaining, from the UE, an indication of one or more parameters for determination of the partitioning of the plurality of CBs into the plurality of CBGs according to the partitioning scheme.

In certain aspects, method 1100 further includes obtaining the indication of the one or more parameters via a physical uplink channel.

In some aspects, block 1110 includes obtaining, from the UE, acknowledgment feedback for each CBG of the plurality of CBGs (e.g., the ACK/NACK feedback 718 depicted and described with respect to FIG. 7).

In certain aspects, method 1100 further includes obtaining, from the UE, an additional request to update the partitioning scheme.

In certain aspects, method 1100 further includes sending, to the UE, an approval indication for the additional request.

In certain aspects, method 1100 further includes sending, to the UE, an additional request to update the partitioning scheme.

In certain aspects, method 1100 further includes obtaining, from the UE, an approval indication for the additional request.

In certain aspects, method 1100 further includes performing a redundancy check with the UE for the plurality of CBGs after a determination of the partitioning of the plurality of CBs into the plurality of CBGs according to the partitioning scheme.

In certain aspects, method 1100 further includes sending, to the UE, an indication of a slot number and a periodicity for which the network entity evaluated the channel condition for determination of the partitioning of the plurality of CBs into the plurality of CBGs according to the partitioning scheme.

In certain aspects, method 1100 further includes sending the request for the partitioning scheme via a MAC-CE.

In some aspects, the partitioning scheme comprises a channel-aware partitioning scheme for the plurality of CBGs.

In some aspects, the plurality of CBGs comprises a first CBG and a second CBG, the first CBG comprises a first set of CBs that have a metric corresponding to the channel condition in a first range, and the second CBG comprises a second set of CBs that have the metric in a second range.

In some aspects, the first range indicates a better channel condition than the second range.

In some aspects, the first range and the second range are non-overlapping.

In some aspects, the first set of CBs are non-contiguous with one another in time, the second set of CBs are non-contiguous with one another in time, or both.

In some aspects, a first quantity of CBs in the first set of CBs is different than a second quantity of CBs in the second set of CBs.

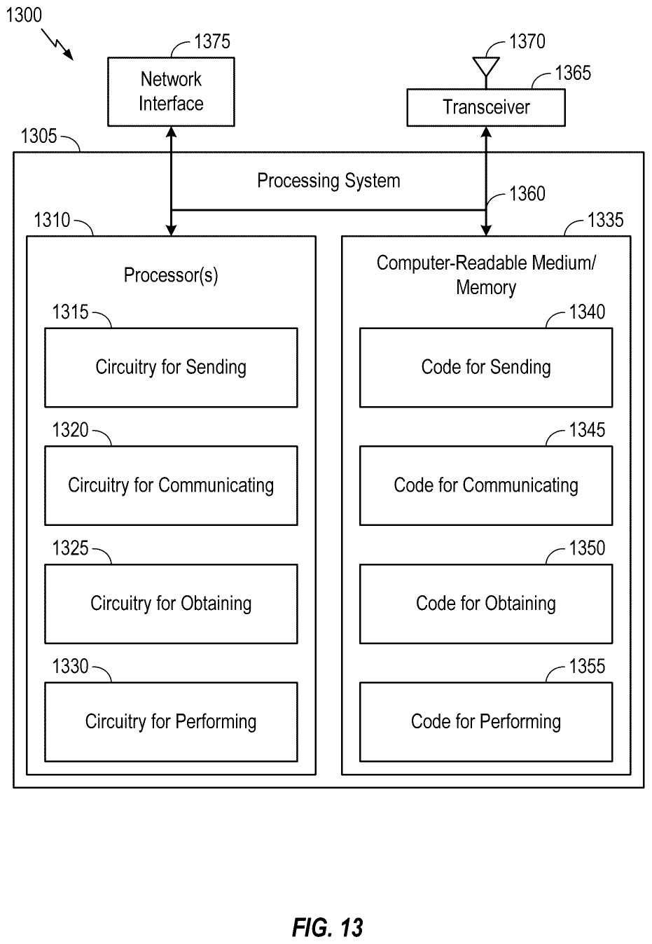

In some aspects, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

In certain aspects, method 1000 may be performed by the apparatus to realize one or more technical effects or solutions to the aforementioned technical problem(s). For example, based on method 1000, the techniques for employing a channel-aware CBG partitioning scheme may reduce the number of CBGs that are retransmitted, thereby reducing signaling overhead and reducing channel usage. In some aspects, the channel-aware CBG partitioning scheme may partition CBs that experience “bad” channel conditions into same CBG(s) and CBs that experience “good” channel conditions into same CBG(s). Accordingly, the CBs that experience the “bad” channel conditions may be confined to a small quantity of CBGs rather than being distributed across a higher quantity of the CBGs. Subsequently, the second device may send NACK feedback indication(s) for the small quantity of CBGs that include the CBs that experience the “bad” channel conditions (e.g., CBs that are unsuccessfully received by the second device), and the first device may retransmit those CBGs, which may be a smaller quantity of CBGs compared to when the CBs are partitioned to CBGs irrespective of the channel condition. As such, the retransmissions may include fewer CBs that were successfully received previously at the second device, thereby reducing wasteful retransmissions.

### Example Communications Devices

FIG. 12 depicts aspects of an example communications device 1200 configured for wireless communications. In some aspects, communications device 1200 is a user equipment, such as UE 104 described above with respect to FIG. 1 or UE 304 described with respect to FIG. 3.

The communications device 1200 includes a processing system 1205 coupled to a transceiver 1265 (e.g., a transmitter and/or a receiver). The transceiver 1265 is configured to transmit and receive signals for the communications device 1200 via an antenna 1270, such as the various signals as described herein. The processing system 1205 may be configured to perform processing functions for the communications device 1200, including processing signals received and/or to be transmitted by the communications device 1200.

The processing system 1205 includes one or more processors 1210 and a computer-readable medium/memory 1235. In various aspects, the one or more processors 1210 may be representative of the one or more processors 318 described with respect to FIG. 3. The one or more processors 1210 are coupled to a computer-readable medium/memory 1235 via a bus 1260. In some aspects, the computer-readable medium/memory 1235 may be representative of the one or more memories 320 described with respect to FIG. 3. The computer-readable medium/memory 1235 is a non-transitory computer-readable medium/memory. In certain aspects, the computer-readable medium/memory 1235 is configured to store instructions (e.g., computer-executable code), that when executed by the one or more processors 1210, cause the one or more processors 1210 to perform the method 1000 described with respect to FIG. 10, or any aspect related to it, including any operations described in relation to FIG. 10. Note that reference to a processor performing a function of communications device 1200 may include one or more processors performing that function of communications device 1200, such as in a distributed fashion.

In the depicted example, computer-readable medium/memory 1235 stores code (e.g., executable instructions), including code for obtaining 1240, code for communicating 1245, code for sending 1250, and code for performing 1255. Processing of the code 1240-1255 may enable and cause the communications device 1200 to perform the method 1000 described with respect to FIG. 10, or any aspect related to it.

The one or more processors 1210 include circuitry configured to implement (e.g., execute) the code stored in the computer-readable medium/memory 1235, including circuitry for obtaining 1215, circuitry for communicating 1220, circuitry for sending 1225, and circuitry for performing 1230. Processing with circuitry 1215-1230 may enable and cause the communications device 1200 to perform the method 1000 described with respect to FIG. 10, or any aspect related to it.

More generally, means for communicating, transmitting, sending or outputting for transmission may include the one or more transceivers 324, one or more antenna 322 and/or processing system 316 of the UE 304 illustrated in FIG. 3, transceiver 1265 and/or antenna 1270 of the communications device 1200 in FIG. 12, and/or one or more processors 1210 of the communications device 1200 in FIG. 12. Means for communicating, receiving or obtaining may include the one or more transceivers 324, one or more antennas 322, and/or processing system 316 of the UE 304 illustrated in FIG. 3, transceiver 1265 and/or antenna 1270 of the communications device 1200 in FIG. 12, and/or one or more processors 1210 of the communications device 1200 in FIG. 12. For example, means for performing of the method 1000 described with respect to FIG. 10, or any aspect related to it, may include the one or more transceivers 324, one or more antennas 322, and/or processing system 316 of the UE 304 illustrated in FIG. 3, transceiver 1265 and/or antenna 1270 of the communications device 1200 in FIG. 12, and/or one or more processors 1210 of the communications device 1200 in FIG. 12.

FIG. 13 depicts aspects of an example communications device configured for wireless communications. In some aspects, communications device 1300 is a network entity, such as BS 102 of FIG. 1, first network entity 300 or second network entity 302 of FIG. 3, or a disaggregated base station as discussed with respect to FIG. 2.

The communications device 1300 includes a processing system 1305 coupled to a transceiver 1365 (e.g., a transmitter and/or a receiver) and/or a network interface 1375. The transceiver 1365 is configured to transmit and receive signals for the communications device 1300 via an antenna 1370, such as the various signals as described herein. The network interface 1375 is configured to obtain and send signals for the communications device 1300 via communications link(s), such as a backhaul link, midhaul link, and/or fronthaul link as described herein, such as with respect to FIG. 2. The processing system 1305 may be configured to perform processing functions for the communications device 1300, including processing signals received and/or to be transmitted by the communications device 1300.

The processing system 1305 includes one or more processors 1310 and a computer-readable medium/memory 1335. In various aspects, one or more processors 1310 may be representative of the one or more processors 308, as described with respect to FIG. 3. The one or more processors 1310 are coupled to the computer-readable medium/memory 1335 via a bus 1360. In certain aspects, the computer-readable medium/memory 1335 is configured to store instructions (e.g., computer-executable code), including code 1340-1355, that when executed by the one or more processors 1310, cause the one or more processors 1310 to perform the method 1100 described with respect to FIG. 11, or any aspect related to it, including any operations described in relation to FIG. 11. The computer-readable medium/memory 1335 is a non-transitory computer-readable medium/memory. Note that reference to a processor of communications device 1300 performing a function may include one or more processors of communications device 1300 performing that function, such as in a distributed fashion.

In the depicted example, the computer-readable medium/memory 1335 stores code (e.g., executable instructions), including code for sending 1340, code for communicating 1345, code for obtaining 1350, and code for performing 1355. Processing of the code 1340-1355 may enable and cause the communications device 1300 to perform the method 1100 described with respect to FIG. 11, or any aspect related to it.

The one or more processors 1310 include circuitry configured to implement (e.g., execute) the code stored in the computer-readable medium/memory 1335, including circuitry for sending 1315, circuitry for communicating 1320, circuitry for obtaining 1325, and circuitry for performing 1330. Processing with circuitry 1315-1330 may enable and cause the communications device 1300 to perform the method 1100 described with respect to FIG. 11, or any aspect related to it.

Various components of the communications device 1300 may provide means for performing the method 1100 described with respect to FIG. 11, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1365, antenna 1370, and/or network interface 1375 of the communications device 1300 in FIG. 13, and/or one or more processors 1310 of the communications device 1300 in FIG. 13. Means for communicating, receiving or obtaining may include the one or more transceivers 312, one or more antennas 314, and/or processing system 306 of the first network entity 300 or the second network entity 302 illustrated in FIG. 3, transceiver 1365, antenna 1370, and/or network interface 1375 of the communications device 1300 in FIG. 13, and/or one or more processors 1310 of the communications device 1300 in FIG. 13. For example, means for performing of the method 1100 described with respect to FIG. 11, or any aspect related to it, may include the one or more transceivers 312, one or more antennas 314, and/or processing system 306 of the first network entity 300 or the second network entity 302 illustrated in FIG. 3, transceiver 1365, antenna 1370, and/or network interface 1375 of the communications device 1300 in FIG. 13, and/or one or more processors 1310 of the communications device 1300 in FIG. 13.

### EXAMPLE CLAUSES

Implementation examples are described in the following numbered clauses:

Clause 1: A method for wireless communications by a UE comprising: obtaining, from a network entity, a request for a partitioning scheme for a plurality of CBGs of a TB, the partitioning scheme indicating a partitioning of a plurality of CBs of the TB into the plurality of CBGs based on a channel condition for transmission of the TB; and communicating with the network entity in accordance with the partitioning scheme.

Clause 2: The method of Clause 1, further comprising obtaining, from the network entity, an indication of a chosen policy for the partitioning scheme, wherein the chosen policy indicates a configuration for the partitioning of the plurality of CBs into the plurality of CBGs for the partitioning scheme.

Clause 3: The method of Clause 2, further comprising obtaining the indication of the chosen policy in the request.

Clause 4: The method of Clause 2, wherein the chosen policy indicates the configuration for the partitioning of the plurality of CBs into the plurality of CBGs for the partitioning scheme based on one or more of: a respective channel capacity for each CB of the plurality of CBs of the TB, respective mutual information values for each CB, respective SNR values for each CB, respective signal strength measurements for each CB, or another metric that represents the channel condition for each CB.

Clause 5: The method of Clause 2, further comprising obtaining, in the indication of the chosen policy, one or more threshold values for the configuration for the partitioning of the plurality of CBs into the plurality of CBGs for the partitioning scheme.

Clause 6: The method of any one of Clauses 1-5, further comprising sending, to the network entity, an indication of whether the request is approved.

Clause 7: The method of Clause 6, wherein: the indication comprises an approval for the request, and the method further comprises communicating with the network entity according to the partitioning scheme in accordance with the approval.

Clause 8: The method of Clause 7, further comprising sending, to the network entity, information indicating a slot at which the UE will begin to use the partitioning scheme.

Clause 9: The method of any one of Clauses 1-7, further comprising: obtaining, from the network entity, a second request for a second partitioning scheme for a second plurality of CBGs of a second TB, the second partitioning scheme indicating a second partitioning of a second plurality of CBs into the second plurality of CBGs based on a second channel condition for transmission of the second TB; sending, to the network entity, an indication that the second request is disapproved; and communicating with the network entity in accordance with an additional partitioning scheme based on the second request being disapproved, the additional partitioning scheme comprising an additional partitioning of the second plurality of CBs into an additional plurality of CBGs irrespective of the second channel condition.

Clause 10: The method of any one of Clauses 1-9, further comprising sending, to the network entity, an indication of one or more parameters for determination of the partitioning of the plurality of CBs into the plurality of CBGs according to the partitioning scheme.

Clause 11: The method of Clause 10, further comprising sending the indication of the one or more parameters via a physical uplink channel.

Clause 12: The method of any one of Clauses 1-11, wherein communicating with the network entity based on the partitioning scheme comprises sending, to the network entity, acknowledgment feedback for each CBG of the plurality of CBGs.

Clause 13: The method of any one of Clauses 1-12, further comprising: sending, to the network entity, an additional request to update the partitioning scheme; and obtaining, from the network entity, an approval indication for the additional request.

Clause 14: The method of any one of Clauses 1-13, further comprising: obtaining, from the network entity, an additional request to update the partitioning scheme; and sending, to the network entity, an approval indication for the additional request.

Clause 15: The method of any one of Clauses 1-14, further comprising performing a redundancy check with the network entity for the plurality of CBGs after a determination of the partitioning of the plurality of CBs into the plurality of CBGs according to the partitioning scheme.

Clause 16: The method of any one of Clauses 1-15, further comprising: obtaining, from the network entity, an indication of a slot number and a periodicity for which the network entity evaluated the channel condition for determination of the partitioning of the plurality of CBs into the plurality of CBGs according to the partitioning scheme; and performing an evaluation of the channel condition for the determination of the partitioning of the plurality of CBs into the plurality of CBGs according to the partitioning scheme based on the indication of the slot number and the periodicity.

Clause 17: The method of any one of Clauses 1-16, further comprising obtaining the request for the partitioning scheme via a MAC-CE.

Clause 18: The method of any one of Clauses 1-17, wherein the partitioning scheme comprises a channel-aware partitioning scheme for the plurality of CBGs.

Clause 19: The method of any one of Clauses 1-18, wherein: the plurality of CBGs comprises a first CBG and a second CBG, the first CBG comprises a first set of CBs that have a metric corresponding to the channel condition in a first range, and the second CBG comprises a second set of CBs that have the metric in a second range.

Clause 20: The method of Clause 19, wherein the first range indicates a better channel condition than the second range.

Clause 21: The method of Clause 19, wherein the first range and the second range are non-overlapping.

Clause 22: The method of Clause 19, wherein: the first set of CBs are non-contiguous with one another in time, the second set of CBs are non-contiguous with one another in time, or both.

Clause 23: The method of Clause 19, wherein a first quantity of CBs in the first set of CBs is different than a second quantity of CBs in the second set of CBs.

Clause 24: A method for wireless communications by a network entity comprising: sending, to a UE, a request for a partitioning scheme for a plurality of CBGs of a TB, the partitioning scheme indicating a partitioning of a plurality of code blocks (CBs) of the TB into the plurality of CBGs based on a channel condition for transmission of the TB; and communicating with the UE in accordance with the partitioning scheme.

Clause 25: The method of Clause 24, further comprising sending, to the UE, an indication of a chosen policy for the partitioning scheme, wherein the chosen policy indicates a configuration for the partitioning of the plurality of CBs into the plurality of CBGs for the partitioning scheme.

Clause 26: The method of Clause 25, further comprising sending the indication of the chosen policy in the request.

Clause 27: The method of Clause 25, wherein the chosen policy indicates the configuration for the partitioning of the plurality of CBs into the plurality of CBGs for the partitioning scheme based on one or more of: a respective channel capacity for each CB of a plurality of CBs of the TB, respective mutual information values for each CB, respective SNR values for each CB, respective signal strength measurements for each CB, or another metric that represents the channel condition for each CB.

Clause 28: The method of Clause 25, further comprising sending, in the indication of the chosen policy, one or more threshold values for the configuration for the partitioning of the plurality of CBs into the plurality of CBGs for the partitioning scheme.

Clause 29: The method of any one of Clauses 24-28, further comprising obtaining, from the UE, an indication of whether the request is approved.

Clause 30: The method of Clause 29, wherein: the indication comprises an approval for the request, and the method further comprises communicating with the UE according to the partitioning scheme in accordance with the approval.

Clause 31: The method of Clause 30, further comprising obtaining, from the UE, information indicating a slot at which the UE will begin to use the partitioning scheme.

Clause 32: The method of any one of Clauses 24-31, further comprising: sending, to the UE, a second request for a second partitioning scheme for a second plurality of CBGs of a second TB, the second partitioning scheme indicating a second partitioning of a second plurality of CBs into the second plurality of CBGs based on a second channel condition for transmission of the second TB; obtaining, from the UE, an indication that the second request is disapproved; and communicating with the UE in accordance with an additional partitioning scheme based on the second request being disapproved, the additional partitioning scheme comprising an additional partitioning of the second plurality of CBs into an additional plurality of CBGs irrespective of the second channel condition.

Clause 33: The method of any one of Clauses 24-32, further comprising obtaining, from the UE, an indication of one or more parameters for determination of the partitioning of the plurality of CBs into the plurality of CBGs according to the partitioning scheme.

Clause 34: The method of Clause 33, further comprising obtaining the indication of the one or more parameters via a physical uplink channel.

Clause 35: The method of any one of Clauses 24-34, wherein communicating with the UE based on the partitioning scheme comprises obtaining, from the UE, acknowledgment feedback for each CBG of the plurality of CBGs.

Clause 36: The method of any one of Clauses 24-35, further comprising: obtaining, from the UE, an additional request to update the partitioning scheme; and sending, to the UE, an approval indication for the additional request.

Clause 37: The method of any one of Clauses 24-36, further comprising: sending, to the UE, an additional request to update the partitioning scheme; and obtaining, from the UE, an approval indication for the additional request.

Clause 38: The method of any one of Clauses 24-37, further comprising performing a redundancy check with the UE for the plurality of CBGs after a determination of the partitioning of the plurality of CBs into the plurality of CBGs according to the partitioning scheme.

Clause 39: The method of any one of Clauses 24-38, further comprising: sending, to the UE, an indication of a slot number and a periodicity for which the network entity evaluated the channel condition for determination of the partitioning of the plurality of CBs into the plurality of CBGs according to the partitioning scheme.

Clause 40: The method of any one of Clauses 24-39, further comprising sending the request for the partitioning scheme via a MAC-CE.

Clause 41: The method of any one of Clauses 24-40, wherein the partitioning scheme comprises a channel-aware partitioning scheme for the plurality of CBGs.

Clause 42: The method of any one of Clauses 24-41, wherein: the plurality of CBGs comprises a first CBG and a second CBG, the first CBG comprises a first set of CBs that have a metric corresponding to the channel condition in a first range, and the second CBG comprises a second set of CBs that have the metric in a second range.

Clause 43: The method of Clause 42, wherein the first range indicates a better channel condition than the second range.

Clause 44: The method of Clause 42, wherein the first range and the second range are non-overlapping.

Clause 45: The method of Clause 42, wherein: the first set of CBs are non-contiguous with one another in time, the second set of CBs are non-contiguous with one another in time, or both.

Clause 46: The method of Clause 42, wherein a first quantity of CBs in the first set of CBs is different than a second quantity of CBs in the second set of CBs.

Clause 47: One or more apparatuses, comprising: one or more memories comprising executable instructions; and one or more processors configured to execute the executable instructions and cause the one or more apparatuses to perform a method in accordance with any one of Clauses 1-46.

Clause 48: One or more apparatuses configured for wireless communications, comprising: one or more memories; and one or more processors, coupled to the one or more memories, configured to cause the one or more apparatuses to perform a method in accordance with any one of Clauses 1-46.

Clause 49: One or more apparatuses configured for wireless communications, comprising: one or more memories; and one or more processors, coupled to the one or more memories, configured to perform a method in accordance with any one of Clauses 1-46.

Clause 50: One or more apparatuses, comprising means for performing a method in accordance with any one of Clauses 1-46.

Clause 51: One or more non-transitory computer-readable media comprising executable instructions that, when executed by one or more processors of one or more apparatuses, cause the one or more apparatuses to perform a method in accordance with any one of Clauses 1-46.

Clause 52: One or more computer program products embodied on one or more computer-readable storage media comprising code for performing a method in accordance with any one of Clauses 1-46.

Clause 53: One or more apparatuses configured for wireless communications, comprising: a processing system that includes one or more processors and one or more memories coupled with the one or more processors, the processing system configured to cause the one or more apparatuses to perform a method in accordance with any one of Clauses 1-46.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus comprising a processing system, the processing system comprising one or more memories and one or more processors coupled to the one or more memories, the processing system configured to cause a user equipment (UE) to:
obtain, from a network entity, a request for a partitioning scheme for a plurality of code block groups (CBGs) of a transport block (TB), the partitioning scheme indicating a partitioning of a plurality of code blocks (CBs) of the TB into the plurality of CBGs based on a channel condition for transmission of the TB; and
communicate with the network entity in accordance with the partitioning scheme.

2. The apparatus of claim 1, wherein the processing system is configured to cause the UE to obtain, from the network entity, an indication of a chosen policy for the partitioning scheme, wherein the chosen policy indicates a configuration for the partitioning of the plurality of CBs into the plurality of CBGs for the partitioning scheme.

3. The apparatus of claim 2, wherein the processing system is configured to cause the UE to obtain the indication of the chosen policy in the request.

4. The apparatus of claim 2, wherein the chosen policy indicates the configuration for the partitioning of the plurality of CBs into the plurality of CBGs for the partitioning scheme based on one or more of:
a respective channel capacity for each CB of the plurality of CBs of the TB,
respective mutual information values for each CB,
respective signal-to-noise ratio (SNR) values for each CB,
respective signal strength measurements for each CB, or
another metric that represents the channel condition for each CB.

5. The apparatus of claim 2, wherein the processing system is configured to cause the UE to obtain, in the indication of the chosen policy, one or more threshold values for the configuration of the partitioning of the plurality of CBs into the plurality of CBGs for the partitioning scheme.

6. The apparatus of claim 1, wherein the processing system is configured to cause the UE to send, to the network entity, an indication of whether the request is approved.

7. The apparatus of claim 6, wherein:
the indication comprises an approval for the request, and
the processing system is configured to cause the UE to communicate with the network entity according to the partitioning scheme in accordance with the approval.

8. The apparatus of claim 7, wherein the processing system is configured to cause the UE to send, to the network entity, information indicating a slot at which the UE will begin to use the partitioning scheme.

9. The apparatus of claim 1, wherein the processing system is configured to cause the UE to:
obtain, from the network entity, a second request for a second partitioning scheme for a second plurality of CBGs of a second TB, the second partitioning scheme indicating a second partitioning of a second plurality of CBs into the second plurality of CBGs based on a second channel condition for transmission of the second TB;
send, to the network entity, an indication that the second request is disapproved; and
communicate with the network entity in accordance with an additional partitioning scheme based on the second request being disapproved, the additional partitioning scheme comprising an additional partitioning of the second plurality of CBs into an additional plurality of CBGs irrespective of the second channel condition.

10. The apparatus of claim 1, wherein the processing system is configured to cause the UE to send, to the network entity, an indication of one or more parameters for determination of the partitioning of the plurality of CBs into the plurality of CBGs according to the partitioning scheme.

11. The apparatus of claim 1, wherein to communicate with the network entity in accordance with the partitioning scheme, the processing system is configured to cause the UE to send, to the network entity, acknowledgment feedback for each CBG of the plurality of CBGs.

12. The apparatus of claim 1, wherein the processing system is configured to cause the UE to:
send, to the network entity, an additional request to update the partitioning scheme; and
obtain, from the network entity, an approval indication for the additional request.

13. The apparatus of claim 1, wherein the processing system is configured to cause the UE to:
obtain, from the network entity, an additional request to update the partitioning scheme; and
send, to the network entity, an approval indication for the additional request.

14. The apparatus of claim 1, wherein the processing system is configured to cause the UE to perform a redundancy check with the network entity for the plurality of CBGs after a determination of the partitioning of the plurality of CBs into the plurality of CBGs according to the partitioning scheme.

15. The apparatus of claim 1, wherein the processing system is configured to cause the UE to:
obtain, from the network entity, an indication of a slot number and a periodicity for which the network entity evaluated the channel condition for determination of the partitioning of the plurality of CBs into the plurality of CBGs according to the partitioning scheme; and
perform an evaluation of the channel condition for the determination of the partitioning of the plurality of CBs into the plurality of CBGs according to the partitioning scheme based on the indication of the slot number and the periodicity.

16. The apparatus of claim 1, wherein:
the plurality of CBGs comprises a first CBG and a second CBG,
the first CBG comprises a first set of CBs that have a metric corresponding to the channel condition in a first range, and
the second CBG comprises a second set of CBs that have the metric in a second range.

17. The apparatus of claim 16, wherein the first range indicates a better channel condition than the second range.

18. The apparatus of claim 16, wherein the first range and the second range are non-overlapping.

19. An apparatus comprising a processing system, the processing system comprising one or more memories and one or more processors coupled to the one or more memories, the processing system configured to cause a network entity to:
send, to a user equipment (UE), a request for a partitioning scheme for a plurality of code block groups (CBGs) of a transport block (TB), the partitioning scheme indicating a partitioning of a plurality of code blocks (CBs) of the TB into the plurality of CBGs based on a channel condition for transmission of the TB; and
communicate with the UE in accordance with the partitioning scheme.

20. A method for wireless communications by a user equipment (UE) comprising:
obtaining, from a network entity, a request for a partitioning scheme for a plurality of code block groups (CBGs) of a transport block (TB), the partitioning scheme indicating a partitioning of a plurality of code blocks (CBs) of the TB into the plurality of CBGs based on a channel condition for transmission of the TB; and
communicating with the network entity in accordance with the partitioning scheme.
